(19) United States
(12) Patent Application Publication
(10) Pub. No.: US 2025/0153979 A1
(43) Pub. Date: May 15, 2025

(54) CRANE

(71) Applicant: Liebherr-Werk Biberach GmbH, Biberach an der Riss (DE)

(72) Inventors: Tobias Scholz, Biberach (DE); Michael Kreger, Schemmerhofen (DE); Sebastian Sturm, Mittelbiberach (DE)

(21) Appl. No.: 18/837,358

(22) PCT Filed: Jan. 27, 2023
(86) PCT No.: PCT/EP2023/052023

§ 371 Date: Aug. 9, 2024

(30) Foreign Application Priority Data
Feb. 11, 2022 (DE) 10 2022 103 283.3

(51) Int. Cl. B66C 13/46; B66C 19/00; G01C 3/08; G06T 7/593; G06T 7/60; H02K 7/10; H02K 7/18; H02K 11/00

(52) U.S. Cl. CPC B66C 13/46; G01C 3/08; G06T 7/593; G06T 7/60; H02K 7/1004; H02K 7/1853; H02K 11/0094; B66C 19/00; G06T 2207/10012

(57) ABSTRACT

A crane, in particular a rotating tower crane, including a crane boom from which a load-receiving means, such as load hooks, can be raised and lowered by means of a hoist rope. A detection device is provided for detecting the distance of the load-receiving means from the ground and/or from an object located below the load-receiving means.

### CROSS-REFERENCE TO RELATED APPLICATIONS

This application is a National Stage of International Application No. PCT/EP2023/052023 filed 27 Jan. 2023, which claims benefit under 35 USC § 365 of DE Application No. 10 2022 103 283.3 filed 11 Feb. 2022, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a crane, for example in the form of a rotating tower crane, comprising a crane boom from which a load-receiving means such as a load hook can be raised and lowered via a hoist rope.

### 2. Description of Related Art

On large cranes such as rotating tower cranes or telescopic boom cranes, loads are often lifted or set down or maneuvered to a certain position at a relatively large distance from a crane operator's cab, making it difficult to see the load hook or the load attached to it from the crane operator's cab. The crane operator's cab can be arranged on the upper part of the tower or directly under the jib in the case of a rotating tower crane or on the superstructure in the case of other crane types such as telescopic boom cranes, wherein the relatively large distance to the load hook or the attached load results on the one hand from the relatively large jib radius and on the other hand can also be due to the height of the boom and the relatively large lowering depth of the load hook. The hoist rope can, for example, run from the boom via a trolley, which can be moved longitudinally on the boom, or also run from the tip of the boom.

In order to be closer to the load hook or the load to be attached, the crane operator can also control the crane movements by means of a remote control, if necessary, in order to be able to see the load hook better for controlling the crane. Alternatively, the crane operator can also work with a banksman who is close to the pick-up or drop-off position at a construction site in order to see the load hook and inform the crane operator of the hook position or give travel instructions, for example from close to the load by radio and/or cell phone and/or hand signals. If no banksman is available or if the connection of the radiotelephone or also the visibility is poor or interrupted, it is not possible to position the load hook more specifically relative to the load to be picked up or the load relative to the drop-off location.

The crane operator usually receives information about the lowering depth of the load hook from the crane's sensor system, which indicates the lowering depth of the load hook under the boom, but for various reasons this cannot replace the information or instructions from the supervisor or also the crane operator's own visual contact in order to maneuver the load hook or the load attached to it precisely to the target. On the one hand, the lowering depth alone is of little help if the ground is uneven or if the height of the load receiving surface or its level difference to the crane's installation site is generally unknown. On the other hand, the actual loads are also often attached to the load hook via a hanger of unspecified length, such as slings or chains. The dimensions of the load itself can also vary or be unknown. As a result, the crane driver does not know the distance between the load hook and the load end or the distance from the load end to objects below or to the ground more specifically and can only make a rough estimate. Another difficulty is working in shafts or behind visible edges, as visibility is poor or non-existent here.

For these reasons, a banksman is almost always required at the pick-up or drop-off location. However, if such a banksman is not available or if the connection of the radio or cell phone or also just the visibility is poor or interrupted, it becomes difficult to maneuver the load hook and the load attached to it safely and to set it down or accommodate it precisely.

Load hook position determination devices have therefore already been proposed, which provide the crane operator with more specific information about the exact position of the load hook. For example, DE 20 2019 102 393 U1 describes a rotating tower crane with several electromagnetic radio modules that are fastened to the boom and the load hook and from whose radio signals an electronic evaluation device determines the position of the load hook. WO 2005/082770 A1 also discloses a rotating tower crane with a downward-looking camera attached to the trolley in order to display a video image of the load hook's surroundings to the crane operator so that the crane operator can better detect obstacles in the direction of movement. Similar video assistance systems are also known from DE 197 25 315 C2, JP 9-142773 and EP 29 31 649 B1. Even if these assistance systems make it easier for the crane operator to position the load hook or the load attached to it more specifically in the horizontal direction or in the horizontal plane, it is still difficult for the crane operator to control the lowering depth of the load hook appropriately and precisely in order to achieve a smooth lowering of the load and a jerk-free accommodation of the load.

It is the underlying object of the present invention to create an improved crane of the type, which avoids the disadvantages of the prior art and further develops the latter in an advantageous manner. In particular, an exact and suitable controlling of the lowering depth of the load hook should also be made possible without a banksman at the pick-up or drop-off location, in order to achieve a gentle setting down and accommodation of a load.

### BRIEF SUMMARY OF THE INVENTION

The task is solved, according to the invention, with a crane comprising a crane boom from which a load-receiving means can be raised and lowered by means of a hoist rope, and a detection device provided on the load-receiving means for detecting the distance of the load-receiving means from the ground and/or from an object located below the load-receiving means.

It is therefore proposed to determine the height of the load-receiving means above the ground or above a surface below it automatically or semi-automatically and to provide the crane controller or the crane operator with height information indicating this height. According to the invention, a detection device is provided on the load-receiving means for detecting the distance of the load-receiving means from the ground and/or from an object located below the load-receiving means. In contrast to conventional lowering depth indicators, the distance from the load-receiving means upwards to the crane boom is not—or not only—measured, but the distance from the load-receiving means downwards to the ground or an object located below the load-receiving means is determined. In this way, suitable maneuvering movements of the load-receiving means can also be precisely controlled without a banksman, even with unknown hangers such as unspecified chains, unknown dimensions or height extensions of the load or non-visible and unknown height levels of the drop-off location or pick-up location, in order to allow a smooth set-down and jerk-free accommodation of a load. In particular, it is not necessary to calculate backwards from the lowering depth, possibly estimating the difference in level between the crane set-up location and the drop-off or pick-up location, in order to determine the exact height distance of the load-receiving means from the relevant contour below the load-receiving means.

In a further development of the invention, the detection device may comprise an optical sensor system with a detection axis directed downwards towards the ground for distance detection. Such optical detection not only permits precise distance detection of the load-receiving means from the ground or from an object located below the load-receiving means, but can also be used to provide the crane operator with optical information about the contours of the suspended load and/or about environmental contours.

Such an optical sensor system can, for example, include a laser measuring head on the load-receiving means, which can determine the distance of the load-receiving means to the ground or to an object located below the load-receiving means with a laser measuring beam directed downwards towards the ground.

In particular, however, the optical sensor system can comprise an imaging sensor system that looks downwards from the load-receiving means and provides an image of the object located below the load-receiving means or the ground there in the manner of a plan view. By means of an image evaluation device, the distance can be determined from the signals of the imaging sensor system.

The imaging sensor system can in particular be configured to operate stereoscopically or stereooptically and comprise two optical sensors and/or cameras spaced apart from one another, each looking downwards or directed downwards, which provide two images of the area located below the load-receiving means from two points spaced apart from one another and thus with two slightly different viewing axes. Due to the offset of the viewing axes of the two optical sensors and/or the two cameras, the image evaluation device can determine the distance of the contour or the surface point, which corresponds to the pixel or image point, from the load-receiving means using the contours and/or pixels and/or image points identified in the images.

A major advantage of optical sensors such as cameras is that they comprise no drift and the accuracy of the distance measurement also does not change over a longer period of time. In addition, the surroundings are not only sensed at specific points, but are mapped over a large area, so that the advantage over other sensor systems is that a large area can be covered with just two sensors or just two cameras. In addition, such a stereo optical sensor system also makes it possible to detect an object located below the load-receiving means in three dimensions or to determine the relative 3D position of an imaged object.

In this respect, the image evaluation can be carried out in various ways. For example, the image evaluation device can comprise a triangulation module that is configured to calculate the depth distance between the sensor or camera plane and the object or ground from the known spacing of the two optical sensors or cameras and the parallax or the displacement of corresponding points between the images.

The two sensors or cameras of the stereoscopic sensor system can advantageously be mounted spaced apart from one another in a horizontal plane in the region of the load-receiving means or arranged at the same height level in the vicinity of the load-receiving means in order to look down onto the ground or an object located below the load-receiving means from at least approximately the same height.

Advantageously, the imaging sensor systems or cameras can be arranged on opposite sides of the load-receiving means and/or comprise viewing or detection axes that are arranged in an upright direction on different sides of the load-receiving means.

In an advantageous further development of the invention, the sensor system can be mounted on a lower block to which the hoist rope is reeved and to which the load-receiving means is fastened, for example in the form of a load hook. Such a lower block usually adopts a predetermined orientation which enables the sensors or cameras mounted on it to look downwards.

For example, a sensor carrier can be attached to the lower block, which can extend approximately coaxially to the axis of rotation of the deflection pulley of the lower block and/or protrude towards the opposite sides of the lower block, so that the sensors or cameras can be mounted looking downwards on opposite sides of the lower block. The carrier may be telescopic and/or retractable and/or hinged so that it can be brought into a non-protruding stowed position and a protruding working position. In the latter, the two sensors or cameras are then spaced apart from one another by a predetermined distance, wherein the distance can form the baseline or base line of the stereoscope system.

In a further development of the invention, the evaluation device, which evaluates the signals from the optical sensor system and determines the distance between the load-receiving means and the ground or an object located below it, can be attached or mounted together with the sensor system in the region of the load hook, so that signal evaluation is possible without a time delay due to longer transmission paths. Alternatively, however, it would also be possible to attach the evaluation device or at least a submodule of the evaluation device to another crane structure component, such as the boom or a tower or generally a slewing platform or an undercarriage, and to evaluate the signals transmitted there by the sensor system in order to determine the distance of the load-receiving means from the ground or an object contour located underneath.

The detection device on the load-receiving means and any other components arranged there, such as the image evaluation device, can be supplied with electric power from a rechargeable battery and/or a battery or generally from an energy storage device. In particular, a signal or data transmission device, with the aid of which the signals from the sensor system and/or the already evaluated distance or height information can be transmitted to a crane controller, can also be supplied with electric power from the energy storage device.

The signal and/or data transmission device can advantageously be configured to operate wirelessly, for example comprising a radio module.

Alternatively, or in addition to an energy storage device on the load-receiving means, electric power can also be generated directly on the load-receiving means, in particular on a lower block connected thereto for deflecting the hoist rope. In an advantageous further development of the invention, a generator for generating electricity can be arranged on the load-receiving means or a lower block connected thereto, which can be driven by a deflection pulley and/or by the hoist rope running around the deflection pulley. For example, the generator can be drive-connected to the deflection pulley via a spur gear or bevel gear stage, or comprise a drive wheel running on the hoist rope.

In this respect, the current provided by the generator can be supplied directly to the energy-consuming device, i.e. the sensor system and/or the evaluation device and/or the data transmission device, possibly via power and/or supply and/or control electronics, and/or at least partially fed into an electrical storage device acting as a buffer, from which the stored energy is then supplied to the respective consumer. Such an electrical buffer can, for example, be a rechargeable battery or a battery or also a capacitor or comprise such components.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a side view of a crane according to an advantageous embodiment of the invention, on the load-receiving means of which a detection device with an imaging sensor system is provided for detecting the distance of the load-receiving means from the ground and/or an object located below the load-receiving means.

FIG. 2 shows the detection device including the imaging, stereooptical sensor system on the load-receiving means of the crane from FIG. 1, wherein the partial views FIGS. 2(a) and (b) show the sensor system on the lower block from horizontal viewing directions tilted at 90° to each other.

FIG. 3 is a side view of the stereoscopic sensor system on the load-receiving means and a load underneath, as well as the two detection areas of the two imaging sensors or cameras of the stereo-optical sensor system, which are displaced relative to each other.

FIG. 4 is a side view of the stereoscopic sensor system similar to FIG. 3, wherein the two mutually offset optical detection areas of the two imaging sensors or cameras falling to the ground are shown without a load attached to the load-receiving means.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

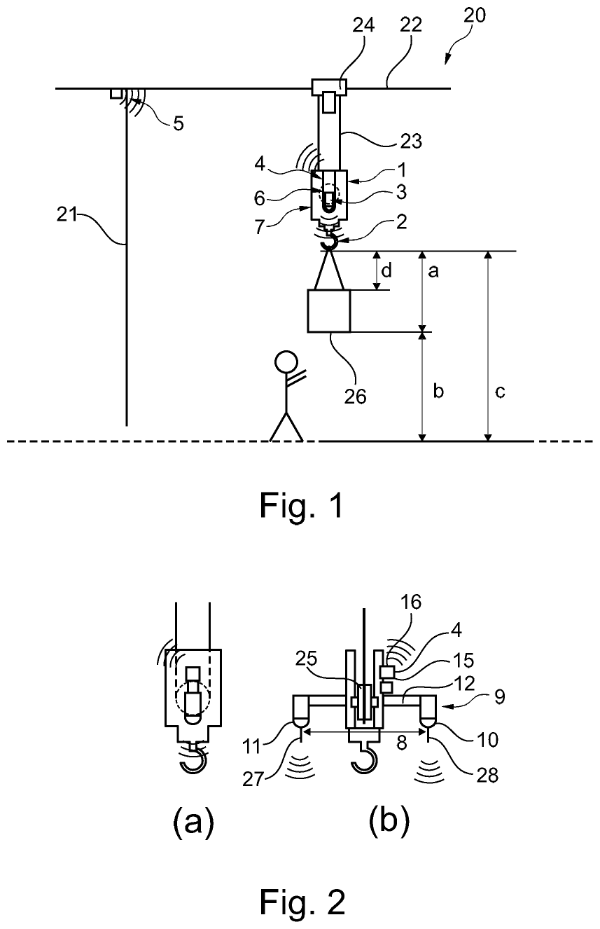

As FIG. 1 shows, the crane 20 can be configured to be a rotating tower crane, for example, and comprise a boom 22 which, in the case of a rotating tower crane, can be attached to a tower 21 and protrude from it. A trolley 24 can be moved along the boom 22 by a trolley drive, wherein a hoist rope 23 can run from the trolley 24 in order to raise and lower a load-receiving means 2 attached to the hoist rope 23, for example in the form of a load hook, and can also be moved horizontally by the trolley 24. In addition, the crane 20 can, for example, be rotated about the upright tower axis by a slewing gear so that the boom 22 pivots. Without being shown, it would also be possible to luff the boom 22 up and down by means of a luffing drive.

The movements of the crane structure and the retracting or lowering of the hoist rope 23 can be used to direct or maneuver the load-receiving means 2 in the desired manner. The crane drives, for example the hoist rope drive, the trolley drive, the slewing gear drive and/or the luffing drive can be controlled by a central crane control device 5, wherein the crane control device 5 can comprise input means such as joysticks, rotary switches or other control buttons in a manner known per se, which enable the crane operator to actuate the crane drives. Alternatively, or additionally, however, the crane control device 5 may also comprise an automatic or semi-automatic module in order to be able to automatically travel predetermined travel paths with the load-receiving means 2.

The load-receiving means 2 in the form of the load hook can be fastened to a lower block 1, to which the hoist rope 23 is reeved, wherein one or more deflection pulleys 25 can be rotatably mounted on the lower block 1 in order to deflect the hoist rope 23, cf. FIG. 2.

A detection device 3 is arranged on the load-receiving means 2, more specifically on the lower block 1, with the aid of which the distance c of the load-receiving means 2 from the ground and/or the distance d of the load-receiving means 2 from the upper edge of a suspended load 26 and/or the distance a of the load-receiving means 2 from a lower edge of the load 26 and/or also the distance b of the lower edge of the load 26 from the ground can be determined. In this respect, the distances a, b, c, d mean the vertical distance and/or the height difference between the load-receiving means 2 and the contours or also from the lower edge of the load 26 to the ground.

The depth information or distances a, b, c, d can be transmitted to the crane control device 5 in order to be displayed or generally output on a display device, which can also be done acoustically if necessary. Preferably, however, the distance can be displayed on a screen.

Alternatively, or in addition to displaying the depth information or distance information a, b, c, d, the crane control device 5 can also use this height or depth information to automatically control a lowering or lifting process.

As the figures show, the detection device 3 comprises a stereoscopic sensor system 9, which comprises two optical or imaging sensors or cameras 10, 11, which have detection axes directed essentially perpendicularly downwards, cf. FIG. 2. In this respect, the two cameras 10, 11 are attached at essentially the same height level.

As FIG. 2 shows, the two cameras 10, 11 are arranged spaced apart from one another transversely to their detection axes, so that a baseline 8 is formed between the detection axes of the cameras 10, 11, which defines a predetermined horizontal distance between the cameras 10, 11.

In an advantageous further development of the invention, the two cameras 10, 11 can be mounted on the lower block 1, in particular on opposite sides thereof. For example, a sensor carrier 12 may protrude towards the opposite sides of the lower block 1, wherein the sensor carrier 12 may extend, for example, approximately coaxially or parallel to the axis of rotation of a deflection pulley 25 on the lower block 1. The cameras 10, 11 can advantageously be arranged towards the opposite sides, in particular approximately equally spaced apart from a hoist rope plane, which is defined by the strands of the hoist rope 23, cf. FIG. 2.

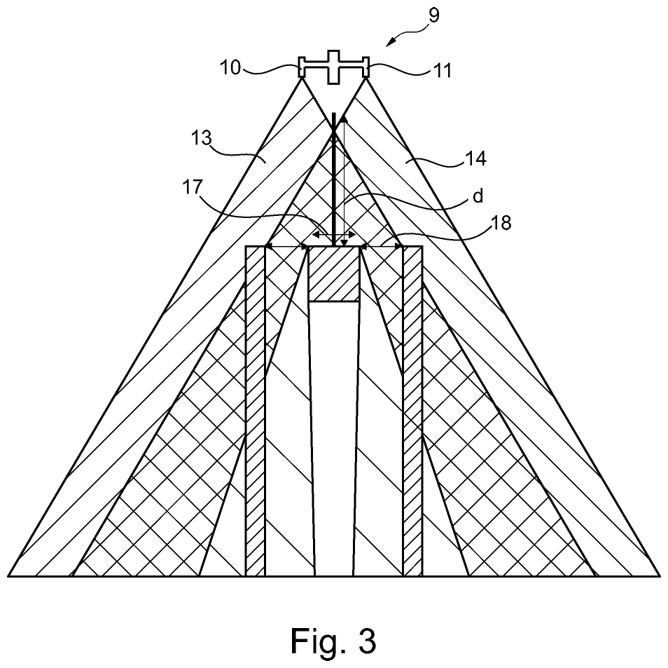

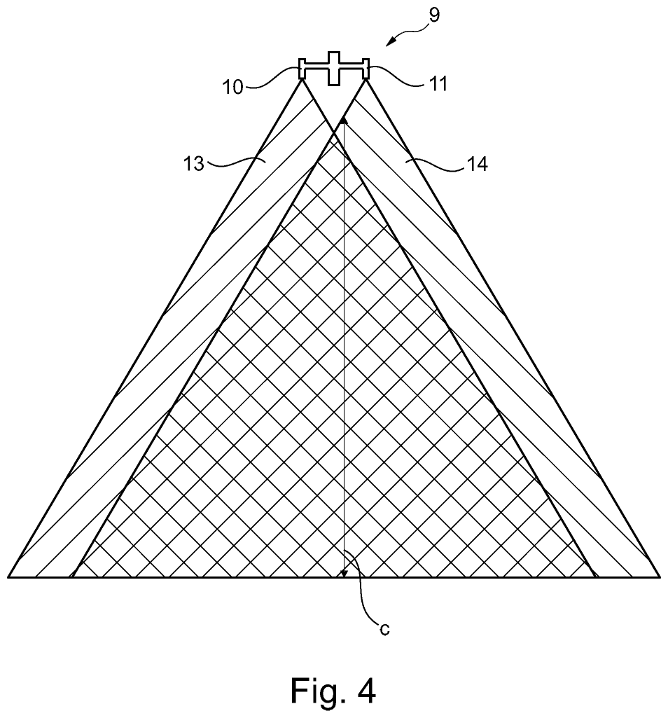

As FIGS. 3 and 4 show, the two cameras 10, 11 each have a detection area 13, 14 directed downwards from the load-receiving means 2, which can widen downwards in a cone shape from the cameras 10, 11. The two detection areas 13, 14 are arranged offset or displaced relative to each other in accordance with the baseline 8 or the spacing of the two cameras from each other. From this parallax or the known length of the baseline 8, the depth distance in the sense of the aforementioned distances a, b, c and/or d can be determined from the images of the cameras 10, 11, more specifically from the displacement of corresponding points between the two images. The image evaluation device 4 provided for this purpose may comprise, for example, a triangulation module 15 which can calculate the depth in terms of the distances a, b, c and/or d from the known baseline 8 and the geometric position of corresponding image points. The image evaluation device 10 can, for example, comprise a computing device including a microprocessor, a program memory and/or data memory for storing a software module and/or the signals to be evaluated.

As the figures show, the image evaluation device 4 can advantageously also be attached to the load-receiving means 2, for example mounted on the lower block 1, in order to determine the depth information a, b, c and/or d from the images of the stereoscopic sensor system 9.

In this respect, the image evaluation device 9 can be supplied with electric power from an energy storage device 6, for example in the form of a battery or a rechargeable battery.

Alternatively, or additionally, a generator 7 can be provided on the load-receiving means 2, in particular on the lower block 1, in order to generate electric power from movements of the hoist rope 23 and/or a deflection pulley 25 of the lower block 1, which can be fed into the energy storage device 6 or can also be provided directly to the image evaluation device 4 and/or the detection device 3, in particular the cameras 10, 11.

Advantageously, the image evaluation device 4, and possibly also the detection device 3, can be connected to a signal and/or data transmission device 16 in order to be able to transmit the depth information a, b, c and/or d and/or also signals from the imaging sensor system to the crane controller 5, preferably wirelessly. The data transmission device 16 can, for example, comprise a radio module in order to transmit the information by radio.

Advantageously, the data transmission device 16 can also be supplied with electric power from the energy storage device 6 and/or fed from the generator 7.

The image evaluation device 4 can advantageously not only determine the depth information a, b, c and/or d, but also determine the contours of the load 26 and/or contours on the ground in a plan view, for example the width and/or length of the load 26 in the plan view and/or its horizontal spacing 18 from viewing axis walls 19, cf. FIG. 3.

The depth information a, b, c and/or d determined by the image evaluation device 4 as well as the contour information, for example in terms of the load width 17 and/or the spacing 18 from the ground surface, can be used by the crane control device 5 in order to control the crane drives in an automated operation and/or can be made available to the crane operator on a display device, wherein the crane operator can control the crane from the crane operator's cab and/or by remote control and/or also by teleoperation. Depending on the situation, the display device can be provided in the crane operator's cab or at the remote control station or a radio remote control.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A crane comprising:
a crane boom from which a load-receiving means can be raised and lowered by means of a hoist rope; and
a detection device provided on the load-receiving means for detecting the distance of the load-receiving means from the ground and/or from an object located below the load-receiving means.

2. The crane according to claim 1, wherein the detection device comprises an optical sensor system with at least one detection axis directed downwards towards the ground for distance detection.

3. The crane according to claim 2, wherein the optical sensor system:
is configured to operate stereooptically; and
comprises two optical sensors and/or cameras spaced apart from one another and each directed downwards towards the ground.

4. The crane according to claim 3 further comprising:
an image evaluation device for evaluating the optical signals and/or images of the optical sensor system;
wherein the image evaluation device is configured to determine the ground and/or object distance of the load-receiving means from the optical signals and/or images.

5. The crane according to claim 4, wherein the image evaluation device comprises a triangulation module for determining the ground and/or object distance by triangulation on the basis of:
the spaced apart spacing of the sensors and/or cameras from one another; and
corresponding image points.

6. The crane according to claim 1, wherein the detection device is mounted on a lower block to which the hoist rope is reeved and the load-receiving means is fastened.

7. The crane according to claim 6, wherein the detection device comprises a sensor carrier protruding from at least one of:
the load-receiving means; or
the lower block.

8. The crane according to claim 3, wherein the two optical sensors and/or cameras of the stereooptical sensor system are arranged on opposite sides of the load-receiving means.

9. The crane according to claim 4, wherein the image evaluation device is mounted together with the optical sensor system on the load-receiving means and/or a lower block connected to the load-receiving means.

10. The crane according to claim 6, wherein the detection device comprises a wireless data transmission device for transmitting the ground and/or object distance to a central crane control device; and
wherein the data transmission device is arranged on at least one of:
the load-receiving means; or
the lower block.

11. The crane according to claim 1 further comprising:
an energy storage device provided on the load-receiving means and for supplying the detection device with electric power.

12. The crane according to claim 6, wherein at least one of the load-receiving means or the lower block comprise a generator for generating electric power from at least one of a movement of the hoist rope or a movement of a deflection pulley deflecting the hoist rope.

13. The crane according to claim 1, wherein the detection device is further configured to detect contour information in a plan view.

14. The crane according to claim 1, wherein:
the crane is a rotating tower crane; and
the load-receiving means is a load hook.

15. The crane according to claim 1, wherein the detection device is further configured to:
detect at least one of a width of the object and/or a horizontal spacing of the object from a contour of the ground surface; and
provide the detected information as plan view information.

16. The crane according to claim 2, wherein the optical sensor system comprises:
two of the detection axes that are directed downwards towards the ground for distance detection, each of the two detection axes being approximately parallel detection axes, each detection axes spaced apart from one another by a baseline; and
two mutually overlapping detection axes.

17. The crane according to claim 2, wherein the detection device comprises a wireless data transmission device for transmitting sensor signals of the optical sensor system to a central crane control device; and
wherein the data transmission device is arranged on at least one of:
the load-receiving means; or
a lower block to which the hoist rope is reeved and the load-receiving means is fastened.

18. The crane according to claim 8, wherein the two optical sensors and/or cameras of the stereooptical sensor system are at substantially the same height levels on opposite sides of the load-receiving means.
